(19) United States
(12) Patent Application Publication
(10) Pub. No.: US 2008/0254198 A1
(43) Pub. Date: Oct. 16, 2008

(54) Method of Preparing Creatine Ester Salts and Uses Thereof

(75) Inventors: Chris Ferguson, Boca Raton, FL (US); Jiang Shengli, Shanghai (CN)

Correspondence Address: AMIN HALLIHAN, LLC, 444 NORTH ORLEANS, SUITE 400, CHICAGO, IL, 60610, US

(73) Assignee: BIO-ENGINEERED SUPPLEMENTS & NUTRITION, INC., Boca Raton, FL (US)

(21) Appl. No.: 12/050,580

(22) Filed: Mar. 18, 2008

Related U.S. Application Data
(63) Continuation of application No. 10/904,389, filed on Nov. 8, 2004, now abandoned.

(51) Int. Cl. A23L 1/29

(52) U.S. Cl. 426/648; 426/442

(57) ABSTRACT

This invention discloses the method of preparation of creatine ester-salts. Creatine is an extremely popular ergogenic aid, and is found most often in the form of creatine monohydrate. Creatine monohydrate is poorly soluble in water however and while esters gain solubility, there functionality is greatly decreased. The material can be administered in a variety of ways including capsules, tablets, powdered beverages, bars, gels, liquids, liposomes or drinks.

This application is a continuation under 37 C.F.R. 1.53(b) of U.S. patent application Ser. No. 10/904,389 filed on 8 Nov. 2004.

### FIELD OF THE INVENTION

The present invention discloses a method of preparing ester salts of creatine and methods of using creatine ester-salts to enhance creatine functionality and bioavailability for purposes of performance and lean mass enhancement, both in humans and animals.

### BACKGROUND

Creatine is the most popular performance enhancing supplement. Although creatine use has dated back to the early 1900's, its use was not commonplace until recent years. The fuel for all muscular work in the body is adenosine tri-phosphate, or ATP. During intense exercise, ATP is utilized very rapidly. The body does not store much ATP in muscle so other substances must be broken down in order to replenish the ATP that is rapidly broken down during exercise. If the ATP is not replenished, fatigue occurs and force/power production declines. Of all the substances in the body that can replenish ATP, the fastest is phosphorylated creatine. Thus, the primary function of phosphorylated creatine in muscle is to buffer ATP by preventing decreases in ATP during exercise and restoring ADP to its original tri-phosphate energy-producing form.

Creatine is taken up into tissues, such as skeletal muscle, by means of an active transport system that typical involves an insulin dependent pathway and sodium gradient. Typical levels of total creatine in skeletal muscle prior to administration are between about 100 to about 140 mmol/kg of dry muscle. The most common form of creatine used is Creatine monohydrate which has fairly poor solubility, particularly at a neutral pH and lower temperature fluids. Other forms of creatine have been introduced to the market such as micronized versions and other forms including magnesium bound, titrate, malate and many others.

U.S. Pat. No. 6,211,407 discloses a method of preparing a dicreatine citrate or tricreatine citrate, comprising two and three creatine cations per citrate anion, respectively.

Patent Application #20040077902 discloses Dicreatine maleate and methods of manufacturing a form of creatine which offers a level of water solubility more than 12 fold better than creatine monohydrate.

U.S. Pat. No. 6,166,249 discloses creatine pyruvates, for use to enhance long-term performance and strength in the field of sport, to reduce weight and body fat in the field of health, to treat conditions of oxygen deficit (ischemia), obesity and overweight, as food supplements and radical scavenger.

These forms all tout to offer various enhancements in functionality and bioavailability, but research is greatly lacking and their efficacy is questionable. As stated above, creatine is not particularly soluble, nor is it very well absorbed from the gastrointestinal tract. Thus, to achieve an effective dose, fairly large amounts of creatine are typically consumed, typically in excess of 10 grams per day, oftentimes 20 grams or more. In addition to the added expense, side effects are often seen with these higher doses and can cause side effects such as bloating and gastrointestinal distress.

To alleviate some of the original inherent flaws of creatine in recent years its use has been coupled with carbohydrates based upon research that suggested the insulin spike generated from the carbohydrates facilitated the transport of creatine into skeletal tissue. For example, in a study by Stengee et al., insulin was co-infused along with creatine supplementation. (Am. J. Physiol., 1998; 275:E974-79). The results of this study indicated that insulin can enhance creatine accumulation in muscle, but only if insulin levels are present at extremely high or supra-physiological concentrations. Stengee et al. refers to a previous study by Green et al. which involved experimentation with ingestion of creatine in combination with a carbohydrate-containing solution to increase muscular uptake of creatine by creating physiologically high plasma insulin concentrations. Stengee et al. reports that Green et al. had found the quantity of carbohydrate necessary to produce a significant increase in creatine uptake, as compared to creatine supplementation alone, was close to the limit of palatability. Theoretically, the more creatine that can be given at the moment of highest insulin concentration would promote the most rapid absorption of creatine into muscles and thus would provide maximum benefit to creatine users.

Also, in recent years combining creatine with various other insulin potentiating agents aside from carbohydrates has become quite common. Agents such as Pinitol, alpha-lipoic acid, 4-hydroxyisoleucine, taurine, arginine, chromium and many others have been used either in conjunction or in replacement of carbohydrates. Similar to the data above on carbohydrates and increased creatine deposition, it is often theorized that agents like these that purport to have effects on glucose control and insulin release can act to increase the absorption and deposition of creatine into the muscle cells.

In common practice in the pharmaceutical world today is the use of various esters and ethers, known agents to increase the solubility of chemicals. Recently a similar technology has been employed to the use of creatine due its known functional benefits of enhancing the solubility and potentially bioavailability of the compound. Therefore, compared with other forms of creatine, ethers and esters have greater solubility and permeability across the GI tract. Since, the more carbons the ester has, the lower the water solubility becomes and the higher the partition coefficient, the preferred ester for creatine is one with few carbons on the ester chain. Once in the GI tract, Creatine esters are converted by esterases in the intestine and blood to the biologically active form or unbound form of creatine. This applies however only to creatine that is delivered via a liquid. If the creatine is to be delivered via a softgel, liposomal or other oil based delivery system, the number of carbons should be much higher with a lower partition coefficient. From that point creatine can then be taken up and utilized by the muscle cells in typical fashion. In addition, creatine esters are resistant to the common conversion to creatinine in the acid environment of the stomach, another factor known to reduce bioavailability of creatine. Therefore, for maximum absorption and protection of the creatine molecule, esters or ethers of creatine should be utilized. However, one flaw with esters is that they have a particularly bad taste and therefore greatly lack in functionality.

Thus it is the object of this invention to disclose a method of preparing an ester-salt of creatine that 1) has increased bioavailability of creatine and 2) maintains and improves upon the functional nature and diversity of creatine by enhancing solubility and taste. Additionally, this invention will detail the methods of use of creatine-ester containing salts for purposes of performance and lean mass enhancement, both in humans and animals.

### SUMMARY

Disclosed herein is: (a) A method of preparing ester salts of creatine. (b) A dietary supplement comprising of creatine ester-salts and/or derivatives thereof, and (c) methods of increasing creatine functionality and bioavailability in mammalian muscle, and enhancing athletic performance and lean body mass comprising administration of said dietary supplement.

### BRIEF DESCRIPTION OF THE PREFERRED EMBODIMENT

Accordingly, it is an object of the invention to provide a method and a dietary supplement which will enhance the uptake of creatine into mammalian muscle. More specifically, it is an object of the invention to provide a method and a dietary supplement which will enhance the uptake of creatine into skeletal muscle whilst enhancing the functionality of the creatine molecule as well. It is a still further object of the invention to provide a method and a dietary supplement that achieves these objects when administered in physiologically acceptable amounts.

Other objectives, advantages and features of the invention will become apparent from the following detailed description, and from the claims.

### Example 1

Under room temperature, 100 mL water and 159 grams of creatine ethyl ester (1 mol) were added into a reaction flask under agitation, then, 67 grams of malic acid (0.5 mol) was added into the flask. The solution gradually converted from hazy to clean. When the solution is completely clean, remove most of the water by distillation under reduced pressure. The remaining mixture was chilled to 0 Celsius Degree below, filtered the mixture, Dicreatine Ethyl Ester Malate was obtained.

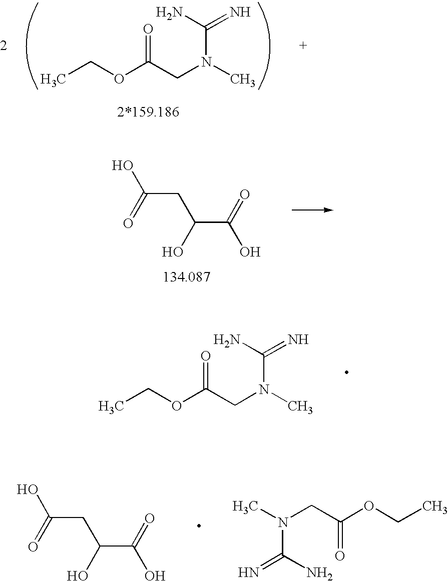

### Example 2

Under room temperature, 159 gram of creatine ethyl ester (1 mol) and 67 grams of malic acid (0.5 mol) were added to 100 mL Alcohol under agitation and stirring for 10 hours. Remove most of the alcohol by distillation under reduced pressure. The remaining mixture was chilled to less than 0 Celsius Degree, filtered the mixture, Dicreatine Ethyl Ester Malate was obtained.

Monocreatine ester malates can be similarly prepared.

### Example 3

Under room temperature, 1000 mL water and 159 grams of creatine ethyl ester (1 mol) were added into a reaction flask under agitation, then, 58 grams of fumaric acid (0.5 mol) was added into the flask. The solution gradually converted from hazy to clean. When the solution is completely clean, remove most of the water by distillation under reduced pressure. The remaining mixture was chilled to 0 Celsius Degree below, filtered the mixture, Dicreatine Ethyl Ester Fumarate was obtained.

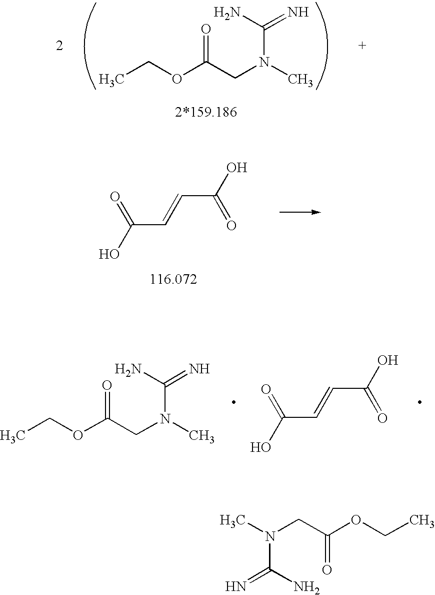

### Example 4

Under room temperature, 159 gram of creatine ethyl ester (1 mol) and 58 grams of fumaric acid (0.5 mol) were added to 100 mL Alcohol under agitation and stirring for 10 hours. Remove most of the alcohol by distillation under reduced pressure. The remaining mixture was chilled to less than 0 Celsius Degree, filtered the mixture, Dicreatine Ethyl Ester Fumarate was obtained.

Monocreatine ester fumarates can be similarly prepared.

### Example 5

Under room temperature, 1000 mL water and 159 grams of creatine ethyl ester (1 mol) were added into a reaction flask under agitation, then, 88 grams of pyruvic acid (1 mol) was added into the flask. The solution gradually converted from hazy to clean. When the solution is completely clean, remove most of the water by distillation under reduced pressure. The remaining mixture was chilled to 0 Celsius Degree below, filtered the mixture, Creatine Ethyl Ester Pyruvate was obtained.

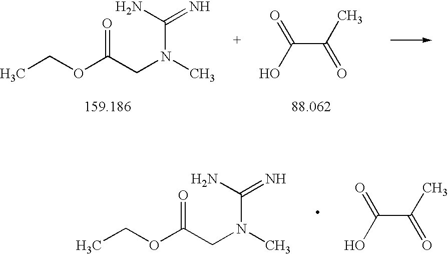

### Example 6

Under room temperature, 159 gram of creatine ethyl ester (1 mol) and 88 grams of pyruvic acid (1 mol) were added to 1000 mL Alcohol under agitation and stirring for 10 hours. Remove most of the alcohol by distillation under reduced pressure. The remaining mixture was chilled to less than 0 Celsius Degree, filtered the mixture, Creatine Ethyl Ester Pyruvate was obtained.

### Example 7

Under room temperature, 159 grams of creatine ethyl ester (1 mol) was mixed with 88 grams of pyruvic acid in a beaker. The mixture is left to stand, ultimately solidifying to a white, finely crystalline product. It was ground in a mortar and dried for 4 hours at 40-60 Celsius Degree. Creatine Ethyl Ester Pyruvate was obtained.

### Example 8

Under room temperature, 159 gram of creatine ethyl ester (1 mol) and 73 grams of Alpha-ketoglutaric acid (0.5 mol) were added to 100 mL Alcohol under agitation and stirring for 10 hours. Remove most of the alcohol by distillation under reduced pressure. The remaining mixture was chilled to less than 0 Celsius Degree, filtered the mixture, DiCreatine Ethyl Ester Alpha-ketoglutarate was obtained.

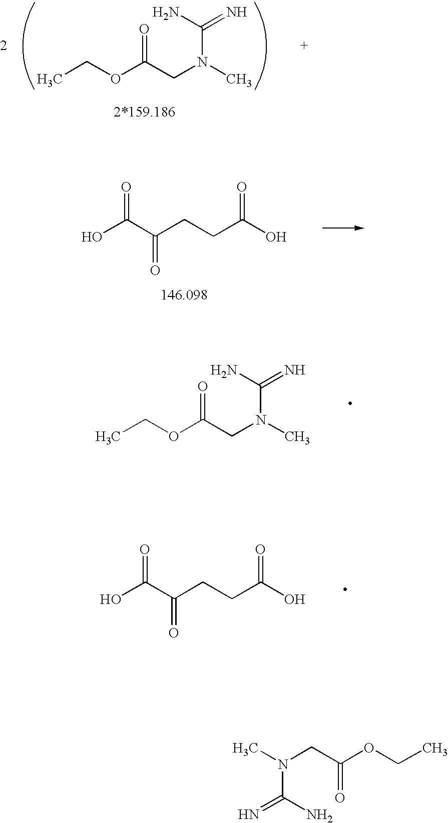

### Example 9

Under room temperature, 100 mL water and 159 grams of creatine ethyl ester (1 mol) were added into a reaction flask under agitation, then, 73 grams of Alpha-ketoglutaric acid (0.5 mol) was added into the flask. The solution gradually converted from hazy to clean. When the solution is completely clean, remove most of the water by distillation under reduced pressure. The remaining mixture was chilled to 0 Celsius Degree below, filtered the mixture, DiCreatine Ethyl Ester Alpha-ketoglutarate was obtained.

Monocreatine ester alpha-ketoglutarates can be similarly prepared.

### Example 10

Under room temperature, 159 gram of creatine ethyl ester (1 mol) and 75 grams of Tartaric acid (0.5 mol) were added to 100 mL Alcohol under agitation and stirring for 10 hours. Remove most of the alcohol by distillation under reduced pressure. The remaining mixture was chilled to less than 0 Celsius Degree, filtered the mixture, DiCreatine Ethyl Ester Tartrate was obtained.

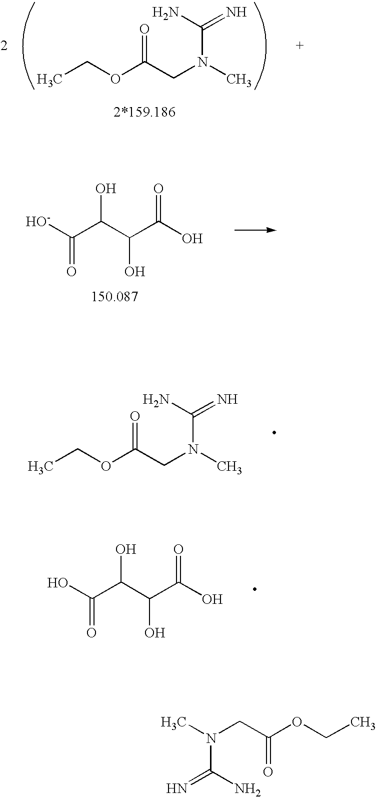

### Example 11

Under room temperature, 1000 mL water and 159 grams of creatine ethyl ester (1 mol) were added into a reaction flask under agitation, then, 75 grams of Tartaric acid (0.5 mol) was added into the flask. The solution gradually converted from hazy to clean. When the solution is completely clean, remove most of the water by distillation under reduced pressure. The remaining mixture was chilled to 0 Celsius Degree below, filtered the mixture, DiCreatine Ethyl Ester Tartrate was obtained.

Monocreatine ester Tartrates can be similarly prepared.

### Example 12

Under room temperature, 159 gram of creatine ethyl ester (1 mol) and 64 grams of Citric acid (0.33 mol) were added to 100 mL Alcohol under agitation and stirring for 10 hours. Remove most of the alcohol by distillation under reduced pressure. The remaining mixture was chilled to less than 0 Celsius Degree, filtered the mixture, TriCreatine Ethyl Ester Citrate was obtained.

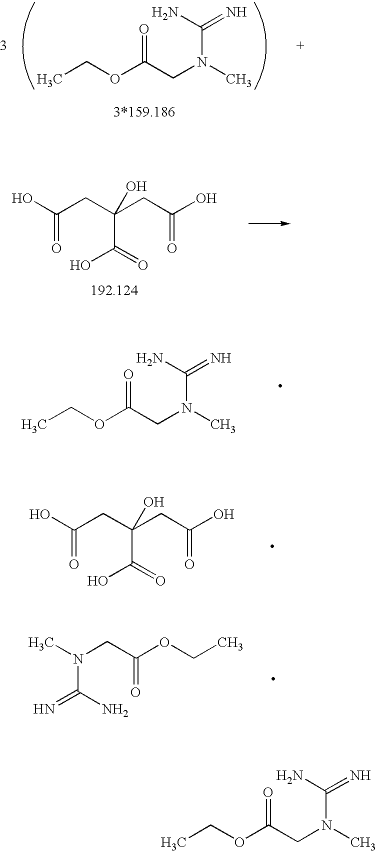

### Example 13

Under room temperature, 1000 mL water and 159 grams of creatine ethyl ester (1 mol) were added into a reaction flask under agitation, then, 64 grams of Citric acid (0.33 mol) was added into the flask. The solution gradually converted from hazy to clean. When the solution is completely clean, remove most of the water by distillation under reduced pressure. The remaining mixture was chilled to 0 Celsius Degree below, filtered the mixture, TriCreatine Ethyl Ester Citrate was obtained.

Monocreatine ester citrates and Dicreatine ester citrates can be similarly prepared.

### Example 14

Under room temperature, 1000 mL water and 159 grams of creatine ethyl ester (1 mol) were added into a reaction flask under agitation, then, 58 grams of Maleic acid (0.5 mol) was added into the flask. The solution gradually converted from hazy to clean. When the solution is completely clean, remove most of the water by distillation under reduced pressure. The remaining mixture was chilled to 0 Celsius Degree below, filtered the mixture, Dicreatine Ethyl Ester Maleate was obtained.

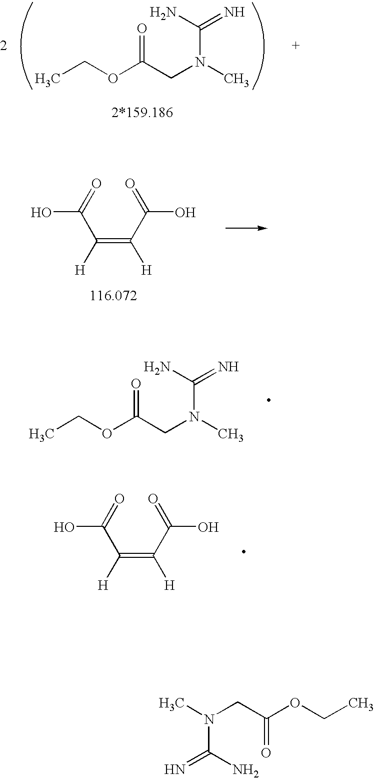

### Example 15

Under room temperature, 159 gram of creatine ethyl ester (1 mol) and 58 grams of Maleic acid (0.5 mol) were added to 1000 mL Alcohol under agitation and stirring for 10 hours. Remove most of the alcohol by distillation under reduced pressure. The remaining mixture was chilled to less than 0 Celsius Degree, filtered the mixture, Dicreatine Ethyl Ester Maleate was obtained.

Monocreatine ester maleates can be similarly prepared.

### Example 16

Under room temperature, 100 mL water and 159 grams of creatine ethyl ester (1 mol) were added into a reaction flask under agitation, then, 176 grams of Ascorbic acid (1 mol) was added into the flask. The solution gradually converted from hazy to clean. When the solution is completely clean, remove most of the water by distillation under reduced pressure. The remaining mixture was chilled to 0 Celsius Degree below, filtered the mixture, Creatine Ethyl Ester Ascorbate was obtained.

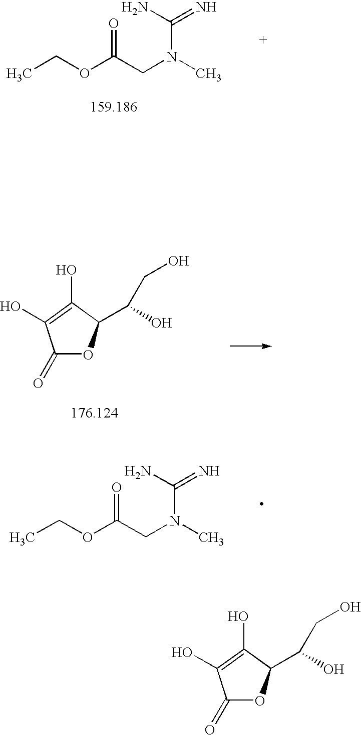

### Example 17

Under room temperature, 159 gram of creatine ethyl ester (1 mol) and 176 grams of Ascorbic acid (1 mol) were added to 1000 mL Alcohol under agitation and stirring for 10 hours. Remove most of the alcohol by distillation under reduced pressure. The remaining mixture was chilled to less than 0 Celsius Degree, filtered the mixture, Creatine Ethyl Ester Ascorbate was obtained.

Potential applications for creatine ester salts:

Formula 1

| | | |
|---|---|---|
| Dicreatine Ethyl Ester Malate | 2.0 | g |
| Alpha-lipoic acid | 100 | mg |
| Magnesium/Potassium Phosphate | 300 | mg |

Formula 2

| | | |
|---|---|---|
| Creatine Ethyl Ester Ascorbate | 1.5 | g |
| 4-hydroxyisoleucine | 200 | mg |
| L-Taurine | 500 | mg |
| D-Pinitol | 50 | mg |

Formula 3

| | | |
|---|---|---|
| Creatine Ethyl Ester Pyruvate | 1.5 | g |
| HMB | 1.0 | g |
| L-Taurine | 500 | mg |
| Cinnamon extract | 200 | mg |

Formula 4

| | | |
|---|---|---|
| TriCreatine Ethyl Ester Citrate | 1.5 | g |
| Ruteacarpine | 50 | mg |
| Cinnamon extract | 200 | mg |
| L-Arginine AKG | 1.5 | g |

### Powdered Formulation

Formula 1

| | | |
|---|---|---|
| Dicreatine Ethyl Ester Malate | 5.0 | g |
| Alpha-lipoic acid | 100 | mg |
| Magnesium Phosphate | 300 | mg |
| Dextrose | 34.0 | g |
| L-Taurine | 1.0 | g |
| L-Glutamine | 2.0 | g |
| Di-potassium phosphate | 200 | mg |
| L-Arginine AKG | 2.0 | g |
| Rutacearpine | 50 | mg |
| Flavor and Sweetener to taste | | |

Formula 2

| | | |
|---|---|---|
| Creatine Ethyl Ester Ascorbate | 1.5 | g |
| 4-hydroxyisoleucine | 200 | mg |
| L-Taurine | 500 | mg |
| D-Pinitol | 50 | mg |
| L-Taurine | 1.0 | g |
| L-Glutamine | 2.0 | g |
| Di-potassium phosphate | 200 | mg |
| L-Arginine AKG | 2.0 | g |
| Cinnamon extract | 200 | mg |
| HMB | 1.0 | g |
| Flavor and Sweetener to taste | | |

Formula 3

| | | |
|---|---|---|
| Creatine Ethyl Ester Ascorbate | 1.5 | g |
| Flavor and Sweetener to taste | | |
| 4-hydroxyisoleucine | 200 | mg |
| L-Taurine | 500 | mg |
| D-Pinitol | 50 | mg |
| L-Taurine | 1.0 | g |
| Betaine HCL | 3.0 | g |
| L-Glutamine | 2.0 | g |
| Di-potassium phosphate | 200 | mg |
| TriCreatine Ethyl Ester Citrate | 1.5 | g |
| Ruteacarpine | 50 | mg |
| Cinnamon extract | 200 | mg |
| L-Arginine AKG | 1.5 | g |
| Glycocyamine | 1.0 | g |

In accordance with certain embodiments, a dietary supplement can include a creatine ester salt having the following structure:

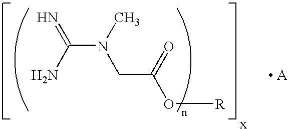

wherein:

x=1 to 6 creatine ester moieties;

A=an organic acid moiety containing 1 to 6 carboxylic acid groups;

n=1 to 6 creatine moieties; and

R=an ester group containing 1 to 35 carbon atoms.

The ester group can be an alkyl or aryl ester group having a straight or branched structure and/or a saturated or unsaturated structure. Additionally, the ester group can contain 1 to 6 hydroxy radicals and/or one or more substituent radicals such as a keto, halide and/or amine radical. In accordance with certain embodiments, 1 to 6 carbon atoms in the ester group can be replaced by nitrogen atoms, oxygen atoms, sulphur atoms, phosphorus atoms or a combination thereof.

Suitable creatine ester moieties for preparing the creatine ester salts of the present invention include, but are not limited to, methyl, ethyl, propyl, isopropyl, butyl, isobutyl, tert-butyl, glyceryl, and benzyl esters of creatine.

Suitable organic acid moieties include, but are not limited to, malic acid, maleic acid, fumaric acid, pyruvic acid, citric acid, tartaric acid, alpha-ketoglutaric acid and ascorbic acid.

In a process for preparing creatine ester salts, a creatine ester compound can be combined with an organic acid in a water solution and/or in organic solvents. Alternatively, the creatine ester compound and organic acid can be combined without any solvents. The creatine ester/organic acid mixture is reacted at temperature between about −60 Celsius degrees to 300 Celsius degrees to produce a creatine ester salt.

A method of enhancing performance, muscle size and/or muscle strength includes administering a dietary supplement including a creatine ester salt in accordance the invention. Suitably, about 10 mg to about 20000 mg of creatine ester salt is administered on a routine basis.

1-10. (canceled)

11. A dietary supplement comprising:
a creatine ester salt including 1 to 6 creatine ester moieties and an organic acid moiety;
each creatine ester moiety including an ester group containing 1 to 35 carbon atoms; and
the organic acid moiety containing 1 to 6 carboxylic acid groups.

12. The dietary supplement according to claim 11, wherein the ester group comprises a straight structure or a branched structure.

13. The dietary supplement according to claim 11, wherein the ester group comprises a saturated structure or an unsaturated structure.

14. The dietary supplement according to claim 11, wherein the ester group contains 1 to 6 hydroxy radicals.

15. The dietary supplement according to claim 11, wherein the ester group comprises a substituent radical selected from the group consisting of a keto radical, a halide radical, an amine radical or a combination thereof.

16. The dietary supplement according to claim 11, where in 1 to 6 of the carbon atoms in the ester group are substituted with a nitrogen atom, an oxygen atom, a sulfur atom, a phosphorous atom or a combination thereof.

17. The dietary supplement according to claim 11, wherein the 1 to 6 creatine ester moieties comprise a creatine alkyl ester, a creatine aryl ester or a combination thereof.

18. The dietary supplement according to claim 11, wherein the 1 to 6 creatine ester moieties comprise a creatine ester selected from the group consisting of creatine methyl ester, creatine ethyl ester, creatine propyl ester, creatine isopropyl ester, creatine butyl ester, creatine isobutyl ester, creatine tert-butyl ester, creatine gylceryl ester, creatine benzyl ester and combinations thereof.

19. The dietary supplement according to claim 11 wherein the organic acid moiety is selected from the group consisting of malic acid, maleic acid, fumaric acid, pyruvic acid, citric acid, tartaric acid, alpha-ketoglutaric acid and ascorbic acid.

20. A method for preparing the dietary supplement according to claim 11, comprising:
reacting a creatine ester compound with an organic acid to obtain the creatine ester salt; and
recovering the creatine ester salt.

21. The method according to claim 20, further comprising:
dispersing the creatine ester compound and the organic acid in a solvent selected from the group consisting of water, alcohol or a combination thereof;
agitating the creatine ester compound/organic acid dispersion for up to about 10 hours;
removing a portion of the solvent to prepare a concentrated solution;
cooling the concentrated solution to precipitate the creatine ester salt; and
filtering the cooled solution to collect the precipitate.

22. A dietary supplement formulation comprising:
a creatine ethyl ester salt including 1 to 6 creatine ethyl ester moieties and an organic acid moiety;
wherein the organic acid moiety contains 1 to 6 carboxylic acid groups.

23. The dietary supplement formulation according to claim 22, wherein the organic acid moiety is selected from the group consisting malic acid, maleic acid, fumaric acid, pyruvic acid, citric acid, tartaric acid, alpha-ketoglutaric acid and ascorbic acid.

24. The dietary supplement formulation according to claim 22, wherein the creatine ethyl ester salt comprises dicreatine ethyl ester malate.

25. The dietary supplement formulation according to claim 22, wherein the supplement comprises about 1.5 grams to about 5.0 grams of the creatine ethyl ester salt.

26. The dietary supplement formulation according to claim 22, further comprising an insulin potentiating agent selected from the group consisting of pinitol, alpha-lipoic acid, 4-hydroxyisoleucine, taurine, arginine and combinations thereof.

27. A method for supplementing a diet, comprising:
administering to a mammal the dietary supplement formulation according to claim 22;
wherein the dietary supplement provides about 10 mg to about 20,000 mg of the creatine ethyl ester salt.

28. A dietary supplement composition comprising:
a creatine ethyl ester salt including 1 to 6 creatine ethyl ester moieties and an organic acid moiety;
at least one insulin potentiating agent selected from the group consisting of pinitol, alpha-lipoic acid, 4-hydroxyisoleucine, taurine, arginine and combinations thereof; and
a phosphate compound.

29. The dietary supplement composition according to claim 28, wherein the creatine ethyl ester salt is selected from the group consisting of dicreatine ethyl ester malate, creatine ethyl ester ascorbate, creatine ethyl ester pyruvate, tricreatine ethyl ester citrate and combinations thereof.

30. The dietary supplement composition according to claim 28, wherein the composition is prepared as a tablet, a capsule, a powdered beverage mix, a bar, a liquid, a liposome or a beverage.
